(19) United States
(12) Patent Application Publication
(10) Pub. No.: US 2026/0257382 A1
(43) Pub. Date: Sep. 3, 2026

(54) HANGING JIG FOR ROBOT, HANGING JIG SET FOR ROBOT, AND ROBOT INSTALLATION METHOD

(71) Applicant: FANUC CORPORATION, Yamanashi (JP)

(72) Inventors: Yosuke AKAHANE, Yamanashi (JP); Atsushi HORIGOME, Yamanashi (JP)

(21) Appl. No.: 18/881,866

(22) PCT Filed: Aug. 22, 2022
(86) PCT No.: PCT/JP2022/031525

§ 371 Date: Jan. 7, 2025

(51) Int. Cl. B25J 19/00; B25J 9/00

(52) U.S. Cl. CPC B25J 19/007; B25J 9/0018

(57) ABSTRACT

A hanging jig for a robot includes: an accessory plate fixed to a bottom surface of a base of the robot; and a frame member that is detachably attached to the accessory plate with the robot fixed thereto and that surrounds at least a part including a center of gravity of the robot. The accessory plate includes an attachment surface with which the bottom surface is in close contact and an installation surface fixed to a mounting surface on which the robot is installed. The frame member includes at least one hook part to which a suspension member is hooked such that the accessory plate with the frame member attached thereto and the robot are suspensible at an installation angle other than 0°.

### CROSS-REFERENCE TO RELATED APPLICATION(S)

This is a National Stage Entry into the United States Patent and Trademark Office from International Patent Application No. PCT/JP2022/031525, filed on Aug. 22, 2022, the entire contents of which are incorporated herein by reference.

### FIELD OF THE INVENTION

The present disclosure relates to hanging jigs for robots, hanging jig sets for robots, and robot installation methods.

### BACKGROUND OF THE INVENTION

A known method for installing a robot onto a mounting surface, such as a ceiling, involves changing the posture of the robot by using a square frame attached to the robot and suspending the robot while maintaining the robot in the changed posture (e.g., see Japanese Unexamined Patent Application, Publication No. Sho 61-071992).

This method involves attaching the square frame to the upper surface of a base of the robot and inverting the entire square frame by 180°, thereby setting the robot in an inverted state and orienting the bottom surface of the base toward the ceiling. In this state, the robot is suspended together with the square frame by using, for example, a crane, and the bottom surface of the base is fixed to the ceiling. Subsequently, the square frame is detached from the robot.

### SUMMARY OF INVENTION

An aspect of the present disclosure provides a hanging jig for a robot. The hanging jig includes an accessory plate fixed to a bottom surface of a base of the robot, and a frame member that is detachably attached to the accessory plate with the robot fixed thereto and that surrounds at least a part including a center of gravity of the robot. The accessory plate includes an attachment surface with which the bottom surface is in close contact, and an installation surface fixed to a mounting surface on which the robot is installed. The frame member includes at least one hook part to which a suspension member is hooked such that the accessory plate with the frame member attached thereto and the robot are suspensible at an installation angle other than 0°.

### BRIEF DESCRIPTION OF THE DRAWINGS

FIG. 1 is a side view illustrating a robot to which a jig according to a first embodiment of the present disclosure is attached.

FIG. 2 is a side view illustrating a state where the robot in FIG. 1 is installed on a floor surface.

FIG. 3 is an enlarged perspective view illustrating a position where the jig and the robot in FIG. 1 are joined to each other.

FIG. 4 is a perspective view illustrating the jig in FIG. 1.

FIG. 5 is a side view illustrating a method for attaching the jig according to the first embodiment of the present disclosure to the robot.

FIG. 6 is a side view illustrating a method for changing the posture of the jig and the robot in FIG. 5.

FIG. 7 is a side view illustrating the method for changing the posture of the jig and the robot in FIG. 5.

FIG. 8 is a side view illustrating the method for changing the posture of the jig and the robot in FIG. 5.

FIG. 9 is a perspective view illustrating an installed state of the robot to which a modification of the jig in FIG. 1 is attached.

FIG. 10 is a perspective view illustrating a state where the robot in FIG. 9 is installed from a direction different from that in FIG. 9.

FIG. 11 is a side view illustrating a method for changing the posture of a jig and a robot in a jig set according to a second embodiment of the present disclosure.

FIG. 12 is a side view illustrating the method for changing the posture of the jig and the robot in FIG. 10.

### DESCRIPTION OF EMBODIMENT(S) OF THE INVENTION

A hanging jig (referred to as “jig 100” hereinafter) for a robot according to a first embodiment of the present disclosure will be described below with reference to the drawings.

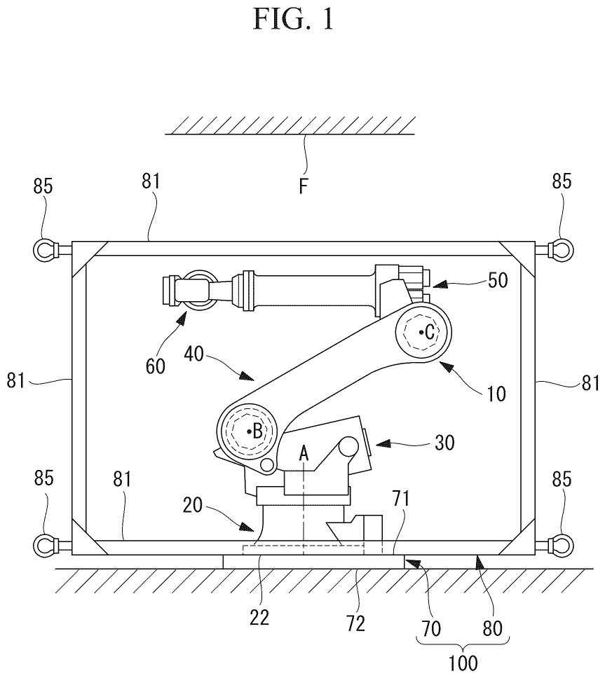

As shown in FIG. 1, the jig 100 according to this embodiment is to be used when installing a robot 10 onto a mounting surface F having an angle other than 0°, such as a wall surface having an angle of 90° or a ceiling surface having an angle of 180°.

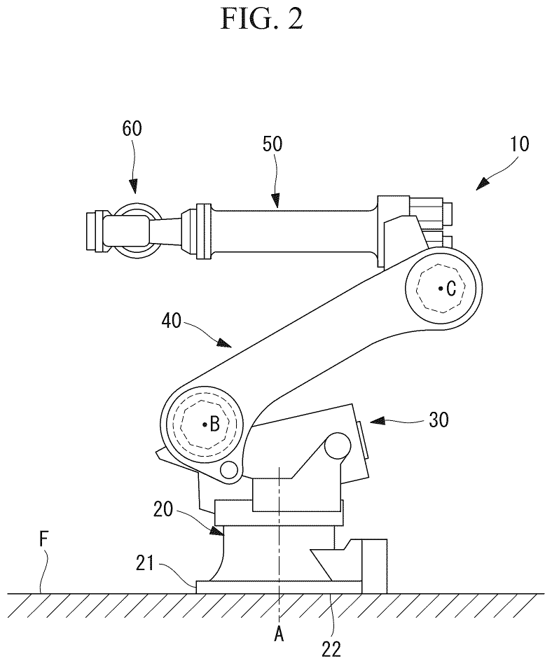

For example, as shown in FIG. 2, the robot 10 is a six-axis vertical articulated robot. The robot 10 includes a base 20 fixed to the mounting surface F and a rotating body 30 supported in such a manner as to be rotatable relative to the base 20 around a first axis A extending in a direction orthogonal to the mounting surface F. The robot 10 also includes a first arm 40 that is rotatable relative to the rotating body 30 around a second axis B extending along a plane orthogonal to the first axis A. Moreover, the robot 10 includes a second arm 50 supported in such a manner as to be rotatable relative to the first arm 40 around a third axis C parallel to the second axis B, and also includes a three-axis wrist unit 60 attached to the distal end of the second arm 50.

As shown in FIG. 2, the base 20 includes a flat leg 21 that extends along the plane orthogonal to the first axis A and that is substantially rectangular in plan view. The leg 21 includes a bottom surface 22 capable of coming into close contact with the mounting surface F.

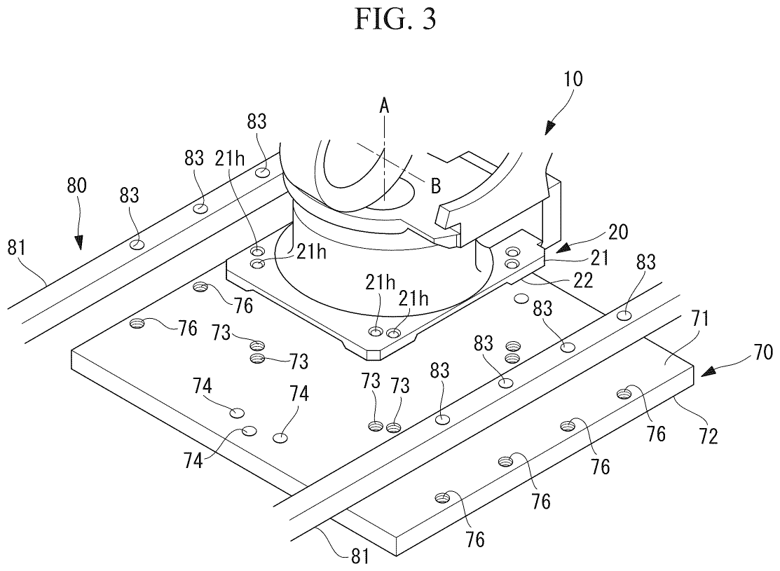

As shown in FIG. 3, the four corners of the leg 21 are provided with a plurality of through-holes 21h extending therethrough in the direction of the first axis A. Bolts (not shown) extending through the through-holes 21h are fastened to threaded holes (not shown) provided in the mounting surface F, so that the robot 10 can be directly installed on the mounting surface F, such as a floor surface, as shown in FIG. 2.

As shown in FIG. 1, the jig 100 includes an accessory plate 70 fixed to the bottom surface 22 of the base 20, and also includes a frame member 80 detachably attached to the accessory plate 70.

The accessory plate 70 is a tabular member formed of a highly rigid material, such as metal, and has a planar shape, such as a rectangular shape, larger than the outer dimensions of the leg 21 of the base 20, as shown in FIG. 3.

The width of the accessory plate 70 is set to be larger than the width of the robot 10 in a transport posture (i.e., the dimension in the direction of the second axis B). As shown in FIG. 2, the transport posture of the robot 10 is a posture in which the rotating body 30 is set at an origin point and the first arm 40 and the second arm 50 are folded.

One side (front side) of the accessory plate 70 in the thickness direction is provided with a flat attachment surface 71 with which the bottom surface 22 of the base 20 is brought into close contact, and the other side (rear side) is provided with an installation surface 72 that is brought into close contact with the mounting surface F.

The attachment surface 71 has threaded holes 73 at positions corresponding to the through-holes 21h when the bottom surface 22 of the base 20 is brought into close contact with the attachment surface 71. The bolts (not shown) extending through the through-holes 21h can be fastened to the corresponding threaded holes 73.

The accessory plate 70 includes a plurality of through-holes 74 extending therethrough in the thickness direction and located outside an area covered by the leg 21 when the base 20 is fixed to the attachment surface 71. Each through-hole 74 has an inner diameter that allows a bolt (not shown) to extend therethrough for fixing the accessory plate 70 to the mounting surface F.

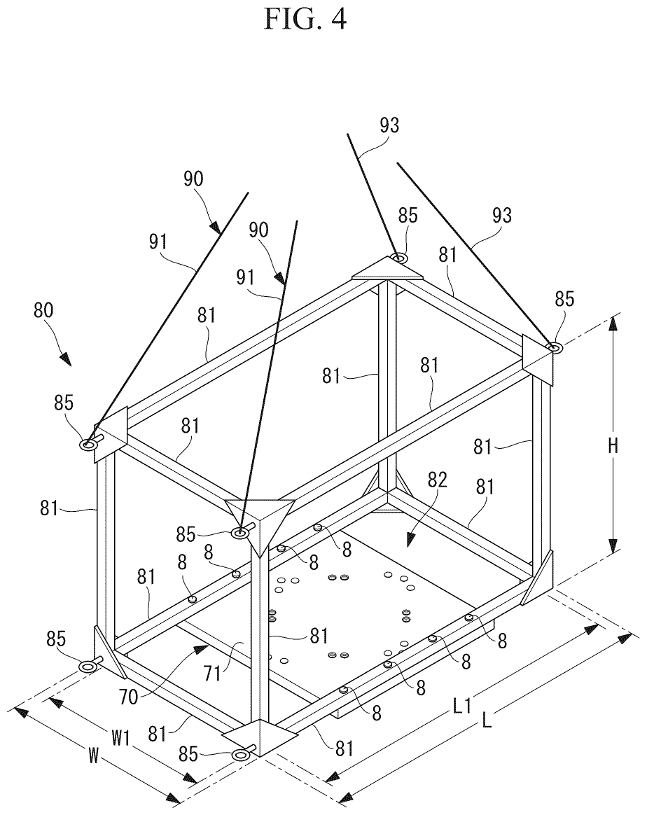

Furthermore, the accessory plate 70 includes a plurality of threaded holes (attachment sections) 76 extending therethrough in the thickness direction and arranged along a pair of outer edges opposite each other in the width direction. Bolts 8 (see FIG. 4) for attaching the frame member 80, to be described later, to the accessory plate 70 are fastenable to the threaded holes 76. The threaded holes 76 are provided with a distance therebetween along the outer edges.

For example, as shown in FIG. 4, the frame member 80 is a highly-rigid rectangular-parallelepiped frame-like structural object obtained by combining 12 rod-like steel members 81, such as prismatic members. The steel members 81 may be joined together by welding such that they cannot be disassembled, or may be joined together by using fastening members, such as bolts, such that they can be disassembled.

The frame member 80 has a width W, a length L, and a height H as outer dimensions. The frame member 80 has an opening 82 with a width W1 and a length L1 as inner dimensions among the four steel members 81 constituting a plane to which the accessory plate 70 is attached.

As shown in FIG. 4, the width W of the frame member 80 is set to be about the same as the width of the accessory plate 70. As shown in FIGS. 1 and 4, the length L of the frame member 80 is set to be larger than the outer dimension of the robot 10 in the front-rear direction (i.e., a direction that extends along a plane orthogonal to the second axis B and that is orthogonal to the first axis A) when the robot 10 is in the transport posture. The height H of the frame member 80 is set to be larger than the outer dimension of the robot 10 in the height direction (i.e., the direction of the first axis A) when the robot 10 is in the transport posture.

The width W1 of the opening 82 in the frame member 80 is set to be larger than the outer dimension of the robot 10 in the width direction (i.e., the direction of the second axis B) when the robot 10 is in the transport posture. The length L1 of the opening 82 is set to be larger than the outer dimension of the robot 10 in the front-rear direction when the robot 10 is in the transport posture.

Specifically, the frame member 80 has therein a space that is larger than the outer dimensions of the robot 10 in the transport posture. Accordingly, in a state where the frame member 80 is fixed to the accessory plate 70, the frame member 80 surrounds the entire robot 10 including the center of gravity thereof. The opening 82 in the frame member 80 has a size that allows the robot 10 in the transport posture to pass through in the direction of the first axis A.

As shown in FIGS. 3 and 4, of the four steel members 81 constituting the plane to which the accessory plate 70 is attached, one set of steel members 81 in the width direction are provided with through-holes 83 at positions corresponding to the threaded holes 76 in the accessory plate 70. By fastening the bolts 8 extending through the through-holes 83 to the threaded holes 76, the frame member 80 is detachably fixed to the attachment surface 71 of the accessory plate 70.

The eight corners of the frame member 80 are provided with hook parts 85 onto which hooks (not shown) at first ends of chains of chain blocks (suspension members) 90 can be hooked. For example, each hook part 85 is a suspension fitting having a ring-shaped section, like an eyebolt, and is to be secured by being fastened to a threaded hole (not shown) provided at the corresponding corner from the outside.

The ring-shaped sections of the eight hook parts 85 are all disposed at the outer sides of the frame member 80, so that the eight ring-shaped sections are disposed surrounding the center of gravity of the robot 10 fixed to the accessory plate 70. Therefore, for example, the jig 100 is lifted upward by using the four hook parts 85 disposed at the upper side of the robot 10 fixed to the accessory plate 70, whereby the robot 10 and the jig 100 are lifted upward in a stable posture.

A robot installation method according to an embodiment of the present invention using the jig 100 according to this embodiment having the above-described configuration will be described below.

Referring to FIG. 2, the following description relates to a case where the robot 10 installable on a floor surface and transported in the transport posture, that is, an upright posture, is installed on the mounting surface F (also referred to as “ceiling surface F” hereinafter), such as a ceiling surface having an angle of 180°.

First, the accessory plate 70 of the jig 100 is separated from the frame member 80 and is disposed on a horizontal surface. Then, the robot 10 is lifted upward by using, for example, a crane, and is hung downward from above the accessory plate 70, thereby bringing the bottom surface 22 of the base 20 into close contact with the attachment surface 71 of the accessory plate 70. The bolts extending through the through-holes 21h provided in the leg 21 of the base 20 are fastened to the threaded holes 73 in the accessory plate 70, whereby the robot 10 is fixed to the accessory plate 70.

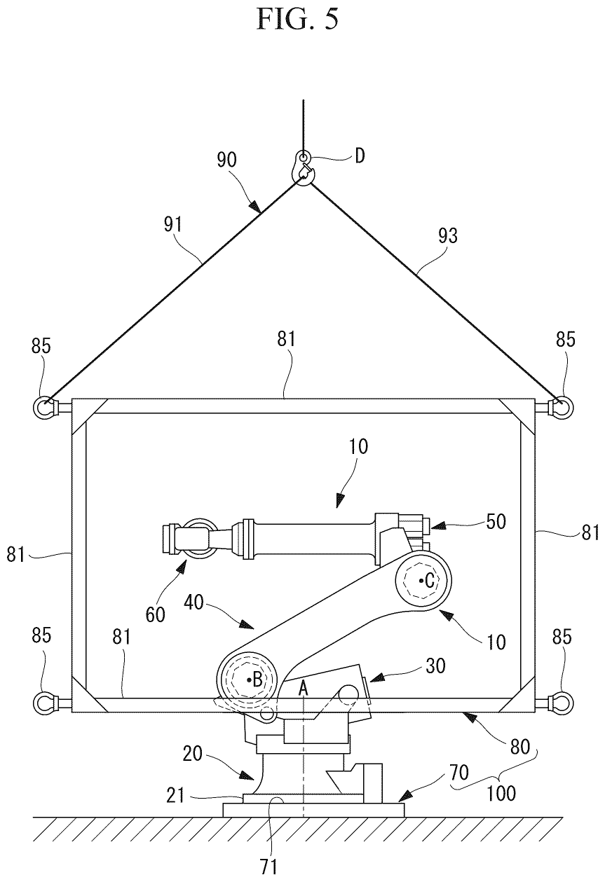

Subsequently, for example, first ends of chains 91 of the chain blocks 90 are hooked onto the two front hook parts 85 among the four hook parts 85 at the upper surface of the frame member 80 (see FIG. 5). First ends of chains (suspension members) 93 each having a fixed length are hooked onto the two rear hook parts 85. Then, the two front chain blocks 90 and the two rear chains 93 are attached to a crane D, and the chain blocks 90 are adjusted such that the four chains 91 and 93 have equal lengths.

The frame member 80 is lifted upward by causing the crane D to ascend, and the frame member 80 is caused to descend from above the robot 10, as shown in FIG. 5. Then, the robot 10 is passed through the opening 82 in the frame member 80, the frame member 80 is brought into contact with the attachment surface 71 of the accessory plate 70, and the bolts 8 extending through the through-holes 83 are fastened to the threaded holes 76 in the accessory plate 70. Accordingly, the frame member 80 is attached while being fixed to the accessory plate 70 and surrounding the entire robot 10.

Then, the crane D ascends again, so that the robot 10 in the upright posture is lifted upward together with the jig 100.

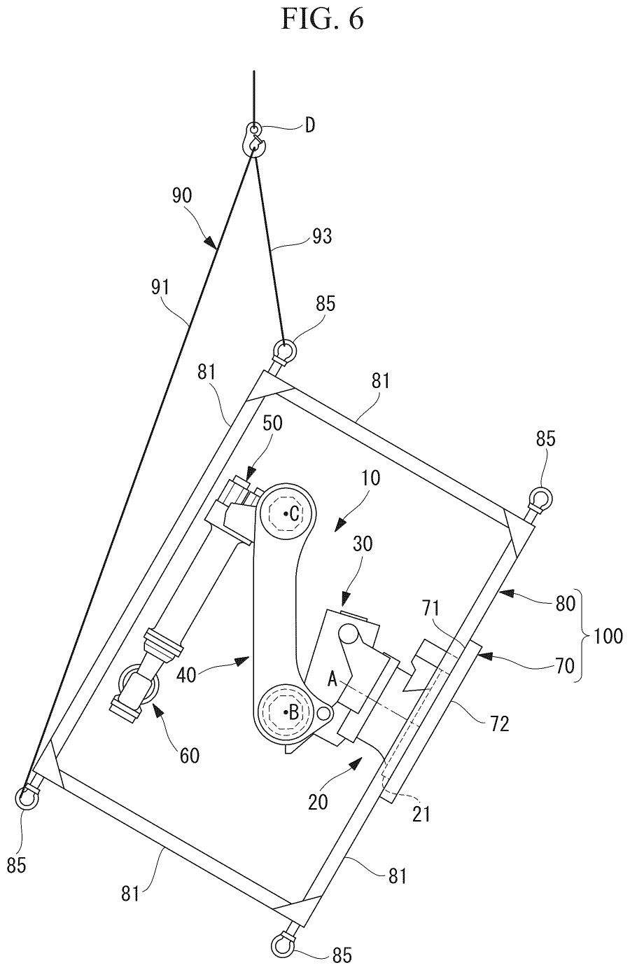

In this state, as shown in FIG. 6, the chain blocks 90 are operated to extend the two chains 91 disposed at the front side of the robot 10, thereby causing the robot 10 and the jig 100 to rotate due to their own weight.

As the chains 91 of the chain blocks 90 are further extended from a state where the center of gravity of the robot 10 and the jig 100 is disposed vertically below the hooks of the crane D, the chains 91 slacken. In this state, the chains 91 are removed from the front hook parts 85 at the upper surface of the frame member 80, and are reattached to the rear hook parts 85 at the lower surface. Then, the chain blocks 90 are operated to adjust the length of the chains 91.

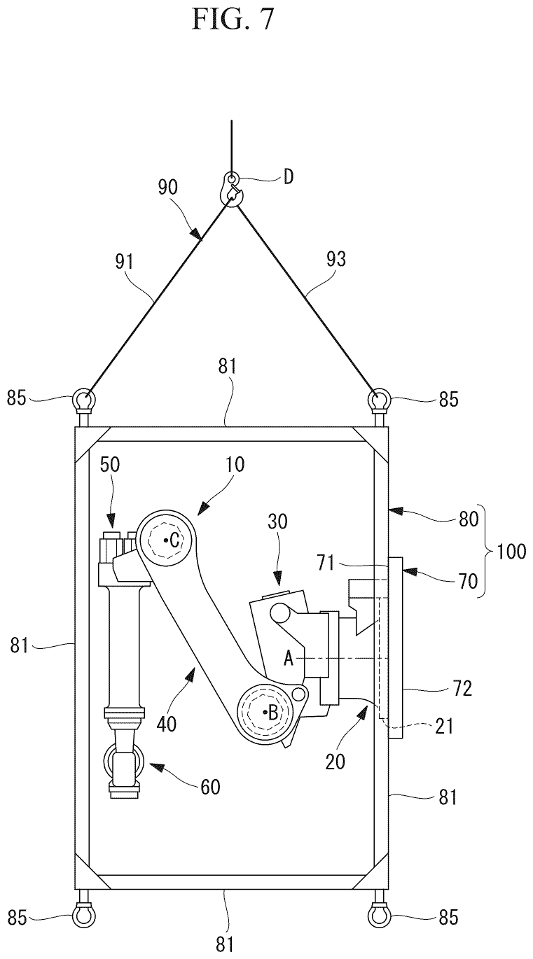

Accordingly, as shown in FIG. 7, the robot 10 and the jig 100 are set in a posture where they have been rotated by 90° around an axis parallel to the second axis B, and are suspended stably.

In this state, the chains 93 having the fixed length are replaced with the chain blocks 90, and the chain blocks 90 are replaced with the chains 93 having the fixed length.

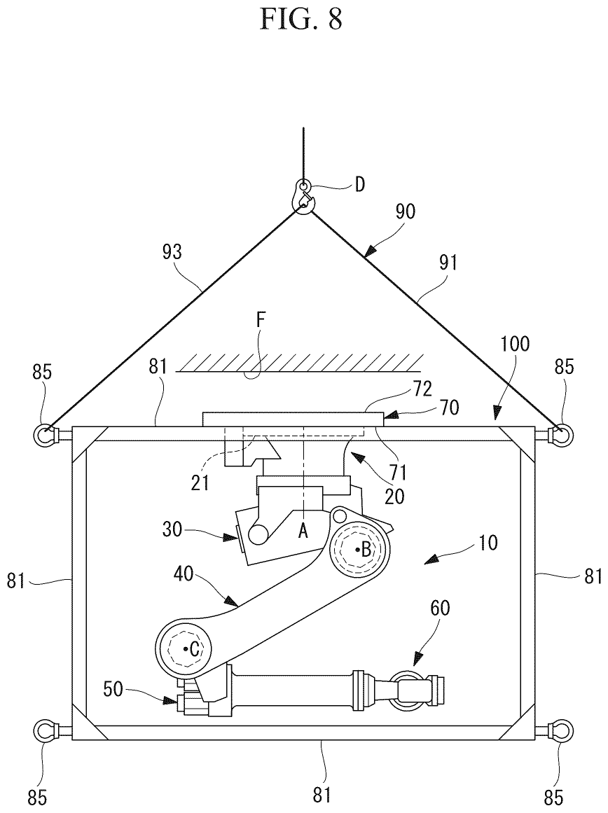

Then, similar to the above, the chains 91 of the replaced chain blocks 90 are extended until they slacken, and are reattached to the hook parts 85, thereby shortening the chains 91 of the chain blocks 90. Accordingly, the robot 10 and the jig 100 are further rotated by 90°. As a result, as shown in FIG. 8, the robot 10 can be set in an inverted posture where it is rotated by 180° from the upright posture. Specifically, the installation surface 72 of the accessory plate 70 attached to the robot 10 can be set facing the downward-facing ceiling surface F.

Then, the crane D ascends to lift the robot 10 and the jig 100 upward, thereby bringing the installation surface 72 of the accessory plate 70 into close contact with the ceiling surface F. Subsequently, bolts (not shown) extending through the through-holes 74 in the accessory plate 70 are fastened to threaded holes (not shown) provided in the ceiling surface F, so that the accessory plate 70 can be fixed to the ceiling surface F.

Consequently, the robot 10 is installed on the ceiling surface F with the accessory plate 70 interposed therebetween. Subsequently, the bolts 8 securing the accessory plate 70 and the frame member 80 to each other are removed, thereby separating the frame member 80 from the accessory plate 70. Then, the crane D descends, so as to cause the frame member 80 to descend relative to the robot 10 installed on the ceiling surface F. Accordingly, the robot 10 is pulled out from inside the frame member 80 through the opening 82 in the frame member 80, and the installation process is completed while the robot 10 is left attached to the ceiling surface F together with the accessory plate 70.

By attaching the accessory plate 70 to the bottom surface 22 of the base 20 in this manner, the frame member 80 can be attached to the robot 10 with the accessory plate 70 interposed therebetween. Therefore, supposing that a space sufficient for attaching another member to a surface other than the bottom surface 22 of the base 20 is not ensured, the frame member 80 can still be attached to the robot 10. By using this frame member 80, the robot 10 can be suspended and changed in posture readily.

Therefore, regardless of the shape of the base 20, the robot 10 can be readily installed on the mounting surface F having an angle other than 0°.

In this case, the robot 10 is accommodated inside the frame member 80 and is not exposed to the outside of the frame member 80. Therefore, when the robot 10 is to be suspended and changed in posture, the possibility of the robot 10 coming into contact with, for example, a peripheral member can be reduced.

The frame member 80 is attached along two outer edges of the accessory plate 70, and the through-holes 74 for attaching the accessory plate 70 to the mounting surface F are disposed in the space between the base 20 fixed to the attachment surface 71 and the frame member 80. Therefore, the accessory plate 70 having the robot 10 and the frame member 80 attached thereto can be readily fixed to the mounting surface F, and the frame member 80 can be readily attached to and detached from the accessory plate 70 fixed to the mounting surface F.

In this embodiment, the frame member 80 is detachably attached to the attachment surface 71 that is located at the front side of the accessory plate 70 and to which the robot 10 is attached. Alternatively, the frame member 80 may be attached to the rear side opposite the attachment surface 71 of the accessory plate 70 in the thickness direction. Specifically, the frame member 80 may be attached in a state where it accommodates not only the robot 10 but also the accessory plate 70 in the inner space thereof.

In this case, a wider available space is ensured outside the area covered by the leg 21 of the base 20 and belonging to the attachment surface 71 of the accessory plate 70 to which the base 20 is attached. Thus, an installation surface to be brought into close contact with the mounting surface F can be set in this available space of the attachment surface 71. Specifically, the installation surface can be disposed in the same plane as the attachment surface 71.

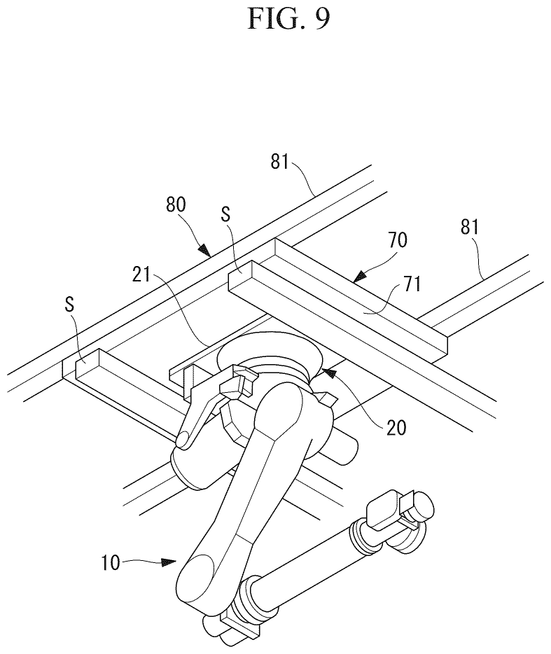

For example, as shown in FIG. 9, this configuration can be applied to a case where the robot 10 is to be installed in a ceiling-suspended state between two beams S protruding horizontally from a wall surface.

In this case, on a floor surface located away from the beams S, the robot 10 having the jig 100 attached thereto is lifted upward by the crane D and is set in the inverted posture, similarly to the above-described method. Then, the crane D ascends until the attachment surface 71 of the accessory plate 70 is positioned slightly higher than the upper surface of the beams S. While maintaining this height position, the crane D is moved in the horizontal direction, so that two beams S are inserted into the frame member 80 through an opening (not shown) in a side surface of the frame member 80, whereby the robot 10 in a suspended state by the crane D is disposed between the two beams S. In this case, since the upper surface of the beams S and the attachment surface 71 of the accessory plate 70 face each other with a small gap therebetween, the attachment surface 71 can be brought into close contact with the upper surface of the beams S by causing the crane D to descend.

Then, similar to the above, after the upper surface of the beams S and the attachment surface 71 are fixed to each other, the frame member 80 is separated from the accessory plate 70. By operating the crane D, the beams S are pulled out through the opening in the side surface of the frame member 80, and the frame member 80 is lowered to the floor surface. Accordingly, the robot 10 can be readily installed in a ceiling-suspended state with the intervention of the accessory plate 70 fixed to the upper surface of the two beams S.

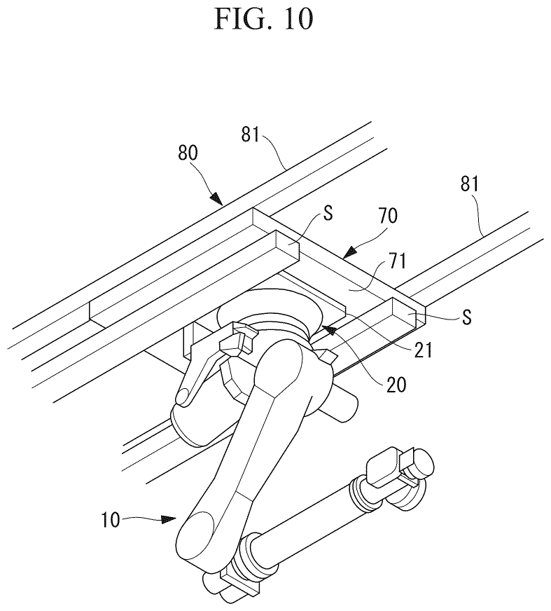

The example shown in FIG. 9 is a case where the attachment surface 71 of the accessory plate 70 is fixed to the two beams S inserted through the opening in the side surface (see FIG. 4) having the length L and the height H of the frame member 80. Alternatively, for example, as shown in FIG. 10, the two beams S may be inserted through a side surface (see FIG. 4) having the width W and the height H of the frame member 80, and the accessory plate 70 may be fixed to the beams S. In this case, in order to detach the frame member 80 from the accessory plate 70 fixed to the beams S and the robot 10, the frame member 80 may be disassembled, and the steel members 81 may be lowered to the floor surface.

Next, a hanging jig set (referred to as “jig set 200” hereinafter) for a robot according to a second embodiment of the present disclosure will be described below with reference to the drawings.

In the following description, sections that share the same configuration as those of the above-described jig 100 will be given the same reference signs, and descriptions thereof will be omitted.

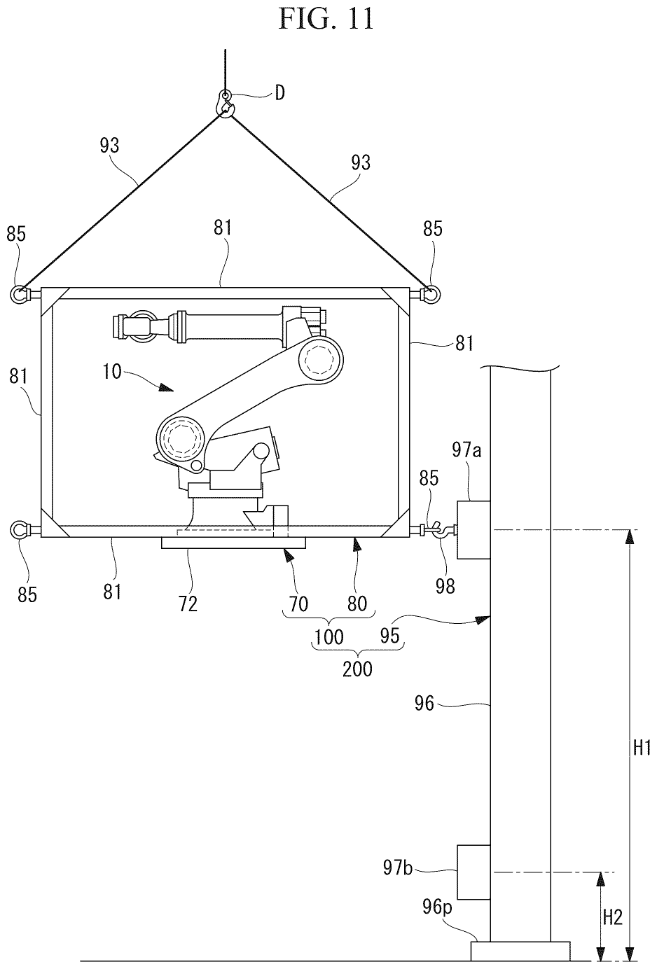

For example, as shown in FIG. 11, the jig set 200 according to this embodiment includes the accessory plate 70, the frame member 80, and a support structure 95 that supports the frame member 80 in a rotatable manner around a horizontal axis.

For example, the support structure 95 includes two pillars 96 extending upward in the vertical direction from a horizontal floor surface, and also includes two beam members 97a and 97b bridged in the horizontal direction between the pillars 96.

Each pillar 96 is, for example, a hollow columnar structural object formed of a highly rigid material, such as metal. The lower end of the pillar 96 is provided with a flange 96p extending around the entire perimeter and protruding outward in a flanged-like fashion from the outer peripheral surface. The flange 96p is fixed to the floor surface in close contact therewith.

The beam members 97a and 97b are formed of the same material as the pillars 96 and each have an elongated plate-like shape. The beam members 97a and 97b are disposed at height positions located away from the floor surface by distances H1 and H2, respectively, and each have their opposite ends fixed to the two pillars 96 by using bolts or by welding.

Accordingly, the pillars 96 and the beam members 97a and 97b have sufficient strength and rigidity for supporting the robot 10 and the jig 100.

In the example shown in FIG. 11, the height H1, at which the beam member 97a is disposed, from the floor surface is set to be larger than the length L (see FIG. 4) of the frame member 80. Two connection fittings (connection sections) 98 connectable to the hook parts 85 of the frame member 80 are attached to the beam member 97a.

For example, if the hook parts 85 are eyebolts, the connection fittings 98 are hooks to which the eyebolts can be hooked. Alternatively, the hook parts 85 and the connection fittings 98 may both be eyebolts, and the eyebolts may be connected by using shackles.

For example, the two connection fittings 98 may be arranged along the longitudinal axis of the beam member 97a with a distance therebetween corresponding to the two rear hook parts 85 at the lower surface of the frame member 80.

The beam member 97b is disposed below the beam member 97a in the vertical direction and with a shorter distance therefrom than the length L of the frame member 80.

The operation of the jig set 200 according to this embodiment having the above-described configuration will be described below.

The following description relates to a case where the robot 10 set in the upright posture and having the jig 100 attached thereto is installed on a wall surface having an angle of 90° in accordance with a method similar to the above.

The first ends of the chains 93 having the fixed length are hooked onto the four hook parts 85 at the upper surface of the frame member 80 of the jig 100 attached to the robot 10 in the upright posture, and the second ends of the chains 93 are attached to the crane D. Subsequently, as shown in FIG. 11, the crane D ascends, so that the two rear hook parts 85 at the lower surface of the frame member 80 are brought closer toward the two connection fittings 98 attached to the beam member 97a of the support structure 95, thereby connecting them to each other.

Accordingly, the robot 10 and the jig 100 are connected to the support structure 95 in such a manner as to be rotatable around a horizontal axis extending through the two connection fittings 98.

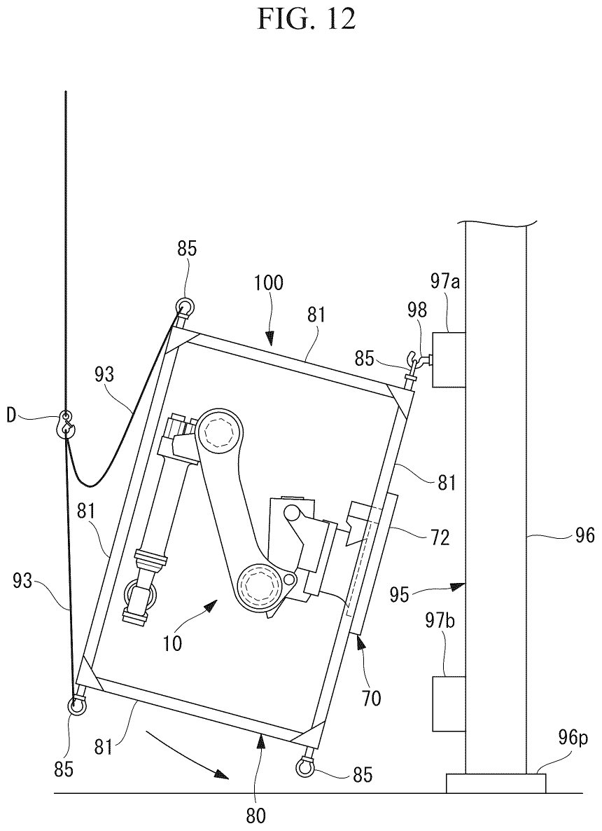

Subsequently, as shown in FIG. 12, the crane D descends, so that the robot 10 and the jig 100 are rotated around the horizontal axis due to their own weight. Then, the two steel members 81 attached to the accessory plate 70 of the frame member 80 are brought into abutment with the beam member 97b. As a result, the robot 10 and the jig 100 become stable in a suspended state from the two connection fittings 98 while being maintained in a 90°-rotated posture from the upright posture.

In this state, the first ends of the four chains 93 are removed and are reattached to the four hook parts 85 disposed at the rear side of the robot 10. Subsequently, the crane D is lifted upward to set the four chains in a non-loosened state, and the hook parts 85 are separated from the two connection fittings 98.

Accordingly, the robot 10 and the jig 100 are suspended in the 90°-rotated posture, so that the installation surface 72 of the accessory plate 70 can be disposed at an angle of 90°. Then, the crane D is operated to bring the installation surface 72 into close contact with the wall surface, thereby fixing the accessory plate 70 to the wall surface. As a result, the robot 10 can be installed on the wall surface with the accessory plate 70 interposed therebetween. Subsequently, similar to the above, the frame member 80 is separated from the accessory plate 70 and is lowered to the floor surface, thereby completing the process for installing the robot 10 on the wall surface.

In this case, the robot 10 and the jig 100 can be changed in posture without having to adjust the length of the suspension members used for suspending the robot 10 and the jig 100. Accordingly, this is advantageous in that the chain blocks 90 do not have to be used so that the workload involved in adjusting the lengths of the chains 91 of the chain blocks 90 can be reduced.

Although the above-described embodiment relates to the case where the robot 10 is installed on a wall surface having an angle of 90°, the same can be applied to a case where the robot 10 is installed on a ceiling surface having an angle of 180°.

In this case, after the robot 10 is changed to a 90°-tilted posture from the upright posture in accordance with the above-described method, the same process may be further performed to change the robot 10 to a 180° inverted posture.

Although the two beam members 97a and 97b are provided between the two pillars 96 in this embodiment, the beam member 97b with which the frame member 80 tilted at 90° is brought into abutment may be omitted. In this case, for example, the lower surface of the frame member 80 rotated by 90° may be supported by using, for example, a forklift, and the posture of the frame member 80 may be maintained in the 90°-rotated state.

Furthermore, the support structure 95 used may be a wall surface in place of the pillars 96.

Although the above embodiments each relate to the six-axis vertical articulated robot 10, the embodiments are not limited thereto. For example, each embodiment may be applied to a case where an industrial robot, such as a horizontal articulated robot or a direct-drive robot, is installed on the mounting surface F having an angle other than 0°.

The above embodiments each relate to a case where the frame member 80 has a size that surrounds the entire robot 10. Alternatively, the frame member 80 may have a size surrounding only a part of the robot 10. In this case, the frame member 80 may be attached to a position surrounding at least the center of gravity of the robot 10.

Accordingly, similar to the above, the robot 10 and the jig 100 can be suspended stably, and can continuously be suspended stably even after the posture thereof is changed in the suspended state.

In this case, if the opening 82 in the frame member 80 is smaller than a projection area of the robot 10, one or more of the steel members 81 may be removed to widen the opening 82, so that the frame member 80 is attachable to and detachable from the robot 10.

Although the hook parts 85 are individually attached to the eight corners of the frame member 80 in each of the above embodiments, the configuration is not limited to this. For example, an arbitrary number of, such as three or more, hook parts 85 may be attached to positions of the frame member 80 surrounding the center of gravity of the robot 10. In this case, the process for reattaching the suspension members when changing the posture of the robot 10 may be performed for each hook part 85.

In each of the above embodiments, the suspension members used are the chain blocks 90 and the chains 93. Alternatively, nylon slings and a winding device for adjusting the length of the slings may be used. Furthermore, although eyebolts are described as the hook parts 85, the hook parts 85 may be holes that are provided at the corners of the frame member 80 and through which the slings or the chains can be inserted.

Although the embodiments of the present disclosure have been described in detail above, the present disclosure is not limited to the individual embodiments described above. For example, various additions, substitutions, modifications, and partial deletions are possible in these embodiments so long as they do not depart from the spirit and scope of the present invention derived from the content described in the claims and equivalents thereof. For example, in the above embodiments, the order of operations and the order of processes are indicated as examples, and are not to be limited thereto.

1. A hanging jig for a robot, the hanging jig comprising:
an accessory plate fixed to a bottom surface of a base of the robot; and
a frame member that is detachably attached to the accessory plate with the robot fixed thereto and that surrounds at least a part including a center of gravity of the robot,
wherein the accessory plate includes an attachment surface with which the bottom surface is in close contact, and an installation surface fixed to a mounting surface on which the robot is installed, and
wherein the frame member includes at least one hook part to which a suspension member is hooked such that the accessory plate with the frame member attached thereto and the robot are suspensible at an installation angle other than 0°.

2. The hanging jig for the robot according to claim 1, wherein the frame member surrounds the entire robot.

3. The hanging jig for the robot according to claim 1, wherein the accessory plate is provided with an attachment section that is located in an area outside the base fixed to the attachment surface and that enables attachment of the frame member.

4. A hanging jig set for a robot, the hanging jig set comprising:
an accessory plate fixed to a bottom surface of a base of the robot;
a frame member that is detachably attached to the accessory plate with the robot fixed thereto and that surrounds at least a part including a center of gravity of the robot; and
a support structure that supports the frame member in a rotatable manner around a predetermined horizontal axis,
wherein the accessory plate includes an attachment surface with which the bottom surface is in close contact, and an installation surface fixed to a mounting surface on which the robot is installed, and
wherein the frame member includes at least one hook part to which a suspension member is hooked such that the accessory plate with the frame member attached thereto and the robot are suspensible at an installation angle other than 0°, and also includes a connection section connected to the support structure.

5. A robot installation method for installing a robot on a mounting surface at an installation angle other than 0° by using the hanging jig for the robot according to claim 1, the robot installation method comprising:
fixing the accessory plate to the bottom surface of the base;
attaching the frame member to the accessory plate;
hooking the suspension member to the hook part and suspending the accessory plate with the frame member attached thereto and the robot by using the suspension member such that the accessory plate and the robot are tilted at the installation angle other than 0°; and
detaching the frame member from the accessory plate after the installation surface is fixed to the mounting surface.
